(19) United States
(12) Patent Application Publication
(10) Pub. No.: US 2014/0288979 A1
(43) Pub. Date: Sep. 25, 2014

(54) SYSTEM AND METHOD FOR SELECTING AN INSURANCE CARRIER

(71) Applicant: WILLIS HRH, Nashville, TN (US)

(72) Inventor: Jonathan Prinn, London (GB)

(21) Appl. No.: 14/355,471

(22) PCT Filed: Nov. 1, 2012
(86) PCT No.: PCT/US2012/062963

§ 371 Date: Apr. 30, 2014

Related U.S. Application Data
(60) Provisional application No. 61/554,265, filed on Nov. 1, 2011.

(51) Int. Cl. G06Q 40/08

(52) U.S. Cl. CPC G06Q 40/08
USPC 705/4

(57) ABSTRACT

A computer system and method to match client insurance needs with an insurance carrier including the step of creating profiles for each of a plurality of insurance carriers by collating data from database sources relevant to each of the plurality of insurance carriers, A structured format is provided for a client to indicate insurance needs and a client's insurance needs are matched with collated data to identify at least one of the plurality of insurance carriers.

### CROSS REFERENCE TO RELATED APPLICATIONS

This application claims priority to U.S. application No. 61/554,265, filed Nov. 1, 2011, which is hereby incorporated by reference in its entirety.

### FIELD OF THE INVENTION

The invention relates generally to electronic commerce, and more particularly, to a system and method for selecting an insurance carrier based on collated data.

### BACKGROUND OF THE INVENTION

The process of obtaining insurance coverage typically involves a number of parties. First, an insured must meet with a broker or producer to determine the type and scope of insurance coverage that the insured is considering. Second, the producer must interact with an insurer or carrier to write a policy for the insured. This process has historically involved a lot of paper transactions where paper documents are used to provide information between the parties in a transaction. One problem with the existing systems is that while certain processes have been automated, the process end-to-end to secure insurance coverage is very slow since many of the communications and interactions occur with written documents.

Another problem with the existing systems for securing insurance coverage is insurance companies issue policies to insure against different types of risk. Whether a particular insurance carrier has an interest in covering a particular type of risk is typically determined by a set of rules that are applied based upon that carrier's historical underwriting experience. Insurance agencies generally have multiple contracts with different insurance carriers and act as an agent for the end consumer or business. Based upon the industry and type of risk, the agent makes a determination as to which of their insurance carriers have an appetite to write insurance for the risk.

Historically insurance companies provide the agents with documentation based upon geographic location and the U.S. Government OSHA Standard Industrial Classification (SIC) coding system as to what types of businesses they are interested in writing. When an application for insurance is completed, the agent needs to make a determination as to which carrier(s) they will send the application. Typically, this determination is made by referring to the carriers' documentation or from personal knowledge. Without accurate documentation and/or personal knowledge, an application may be rejected as an inappropriate submission by the insurance carrier, thereby delaying the ability of the agent to provide coverage to the business.

What is needed is an improved electronic system and method for selecting an insurance carrier.

### SUMMARY OF THE INVENTION

The purpose and advantages of the invention will be set forth in and apparent from the description that follows. Additional advantages of the invention will be realized and attained by the devices, systems and methods particularly pointed out in the written description and claims hereof, as well as from the appended drawings. To achieve these and other advantages and in accordance with the purpose of the invention, as embodied, the invention includes, in one aspect, a system adapted and configured to collate relevant data to create insurance carrier profiles, and then apply a software driven algorithm to match appropriate insurance carriers to clients. It provides information to brokers to help them select proper insurance carriers for their clients' needs, and collects data which can be used with insurance carriers to help develop better client solutions and products.

In another aspect, the present invention provides a scientific approach to the process of market appraisal, which is currently wholly reliant on individual brokers' knowledge and contacts. It is noted the present invention does not seek to replace the current system, but to combine the personal approach with a much broader range of markets, a deeper understanding of client priorities, and improved transparency across the entire process. In one illustrated embodiment, the present invention provides an interface in which clients' needs can be inputted and the client can weigh the importance of each profile score. The present invention system preferably produces a static score with the top three scored markets appearing as potential matches. Users can utilize the matches and provide the reasoning behind their decision. The outcomes of each placement are recorded and fed back to the system.

Still further, the present invention system allows “Active Carriers” (insurance carriers that agree to pay a fee for enhanced services) to review their profile and discuss adjusting their profile across a range of factors, including Class, Line and Product, and Client types by size, location, segment and industry group.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is an illustrated embodiment of a computering device used with the present invention;

FIG. 2 is an illustrative embodiment of a system level diagram depicting the present invention; and

FIG. 3 depicts an exemplary screen shot indicating analysis results

### WRITTEN DESCRIPTION OF CERTAIN EMBODIMENTS OF THE INVENTION

The present invention is now described more fully with reference to the accompanying drawings, in which an illustrated embodiment of the present invention system and method for identifying and selecting an insurance carrier is shown. The present invention system and method for selecting an insurance carrier is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

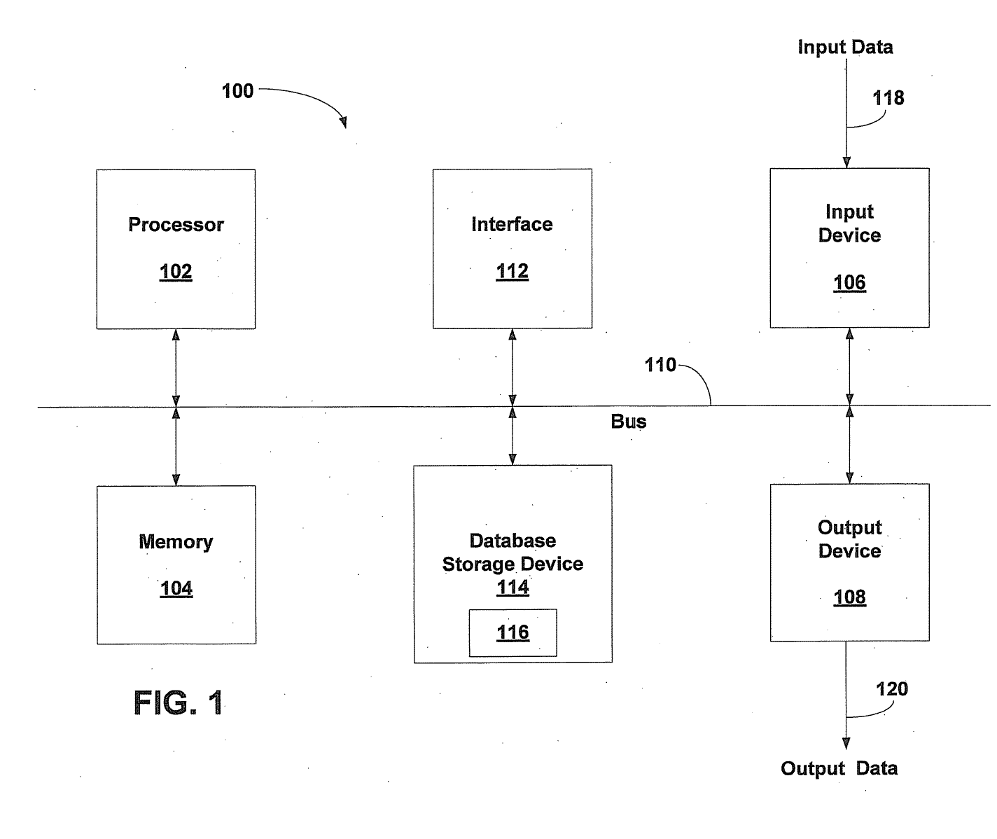

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, a tablet device, a smart phone device or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

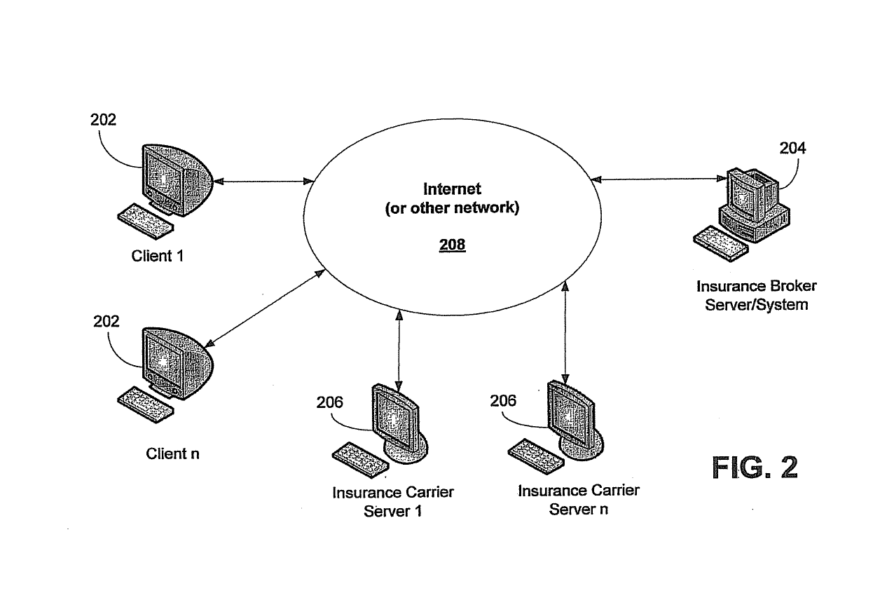

With the exemplary computing system environment 100 of FIG. 1 being generally shown and discussed above, a high level block diagram of an exemplary network communications system 200 capable of employing the teachings of the present invention is illustrated in FIG. 2. Typically, the system 200 includes one or more client devices 202, one or more insurance broker website server/system 204 embodying software/algorithms in accordance with the present invention, and one or more insurance carrier servers 206. Each of these devices may communicate with each other via a connection to the Internet or some other wide area network 208.

It is to be appreciated and understood the present invention generally is adapted and configured to collate knowledge globally and then leverages that knowledge to identify those markets that are scientifically evaluated as the best potential matches a client(s) 102 insurance carrier needs. It is to be further appreciated and understood the collated knowledge can be broadly categorized as “bottom-up” and “top-down” intelligence.

Bottom-Up
Data accumulated through the placement activity of all users of the system globally on:
   Which markets are opined best for each client situation (based on factors such as, industry sector, size, location, risk type and client priorities) and why;
   Which markets respond when asked to quote, how they respond and why;
   Which markets are ultimately chosen and why.

Top-Down

Data relating to:
Predicted appetites (interest) of an insurance carrier based on detailed analysis of historical placement data retrieved from broking systems;
Vetted market intelligence gathered from insurance carriers preferably in terms of appetites for different categories of risk; and
Ad hoc intelligence on related market developments.

It is to be understood and appreciated that the depth of the above acquired knowledge data grows as more and more risks pass through the system 204. This, combined with techniques to adjust the weighting factors in the software/algorithm (preferably used in the system 204) in a similar manner to a neural network based Expert System, means that present invention system and method is designed to continuously improve over time.

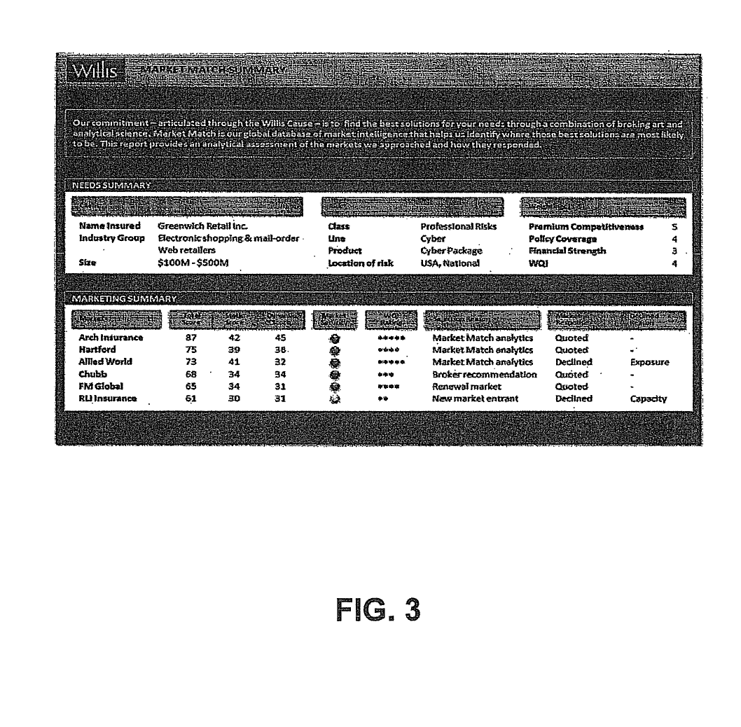

It is also fully anticipated that the present invention software/algorithm is adapted and configured to evolve over time, for example, including additional matching factors, as the goal is clearly to improve the quality of potential matches such that users of system 204 are increasingly better informed when selecting markets to approach. The process of how the present invention software/algorithm operates is herein below described. An exemplary screen shot showing matching results is shown in FIG. 3.

### “Market Match” Inputs and Outputs

For illustrative purposes, the present invention workflow application is herein termed as “Market Match”, which is preferably accessible for use via a web portal interface application. Essentially, details of the insurance risk to be matched are input into Market Match, which provides a set of carriers based on found matches.

In accordance with an illustrative embodiment of the present invention, the insurance carriers identified are the fifty highest scoring insurance carriers as evaluated by the present invention software/algorithm. For instance, for each insurance carrier, Market Match may return the following data:
A rank (which is ‘equal’ if carriers get the same score, for example, 1^{st} equal);
A full breakdown of the score and how that score was computed;
A market security rating;
Content about the carrier's offering for this risk type; and
Flags to indicate important factors to consider when approaching the carrier (for example, a direct/indirect flag—and if indirect, a recommendation of which intermediary to use).

In accordance with the illustrative embodiment of the present invention, the top three (3) insurance carriers are ‘auto-selected’ by Market Match. It is noted if more than 3 insurance carriers qualify as ‘top 3’ (for example, 6 insurance carriers all with the same top score) then all these insurance carriers are auto-selected by the present invention Market Match. It is also noted that if insurance carriers have the same score they are displayed in a random order within that ranking by the present invention Market Match.

Further, and in addition to the fifty highest scoring insurance carriers, the present invention Market Match is adapted and configured to identify all insurance carriers that have been flagged as new market entrants for the present risk type. This status ensures that new entrants are represented during a period when otherwise their dynamic scores may be near zero. After a period (which preferably depends on the carrier and risk type) the new entrant flag is removed and the insurance carrier is treated in the same way as any other insurance carrier.

### Static & Dynamic Scoring

In accordance with the illustrative embodiment, the present invention Market Match software/algorithm preferably computes two types of score: static and dynamic. Static scores are preferably determined by static data—primarily associated with the appetite of a carrier for a particular type of risk. Dynamic scores are preferably based on dynamic data that is preferably aggregated continuously as risks flow through the system. It is to be understood and appreciated the weighting between static and dynamic scores so as to compute a total score is preferably configurable.

### Static Scoring

Table 1 depicts the parameters used by the present invention to calculate static scores.

TABLE 1
STATIC

| | | | |
|---|---|---|---|
| Attributes | Base Score | Weighting | Max Score |

Appetite for:

| | | | |
|---|---|---|---|
| The Class that the product falls within | 0 (Disqualify) or 1 to 5 × | 1 to 5 = | 25 |
| The Line that the product falls within | 0 (Disqualify) or 1 to 5 × | 1 to 5 = | 25 |
| The Specific Product | 0 (Disqualify) or 1 to 5 × | 1 to 5 = | 25 |
| | | | 75 |

+

Appetite for that specific product by:

| | | | |
|---|---|---|---|
| Client Size (turnover band) | 0 (Disqualify) or 1 to 5 × | 1 to 5 = | 25 |
| Client Segment | 0 (Disqualify) or 1 to 5 × | 1 to 5 = | 25 |
| Industry Group (multiple levels) | 0 (Disqualify) or 1 to 5 × | 1 to 5 = | 25 |
| Risk Location (multiple levels) | 0 (Disqualify) or 1 to 5 × | 1 to 5 = | 25 |
| | | | 100 |

| | |
|---|---|
| Note (1): if any of the above dimensions have not been captured in a particular | |
| business unit, the score for all carriers for that dimension is defaulted to 2 | |
| Note (2): if an appetite is set to 0 for any carrier for any dimension then that | + |
| carrier is EXCLUDED from the matching process entirely | |

Willis ratings for each carrier for that product:

| | | | |
|---|---|---|---|
| Premium Competitiveness | 1 to 5 × | Force ranked by client (e.g., 1) = | 5 |
| WQI score - Underwriting | 1 to 5 × | Force ranked by client (e.g., 2) = | 10 |
| WQI score - Service | 1 to 5 × | Force ranked by client (e.g., 3) = | 15 |
| WQI score - Policy Administration | 1 to 5 × | Force ranked by client (e.g., 4) = | 20 |
| WQI score - Claims | 1 to 5 × | Force ranked by client (e.g., 5) = | 25 |
| | | | 75 |
| | | | ÷ |
| | | | 250 |
| | | | = |
| Total Static Score | | | 0 to 1 |

In accordance with the illustrated embodiment of the present invention, it is to be understood and appreciated that if an insurance carrier indicates they have no appetite for a specific product for a particular location, industry, segment or client size, the present invention prescribes the appetite rating to 0 and they will not be returned (identified) by the Market Match software/algorithm. This ensures that the insurance carrier is not approached for any business fitting that profile, otherwise all insurance carriers are considered candidates for the indicated risk.

It is to be further understood and appreciated that if scores for any of the dimensions are unavailable (for example, if for a certain location and class there is no WQI score for the carrier concerned) then a default score is applied based on the average score across all carriers for this risk type.

### Setting Appetites

In accordance with an illustrated embodiment, the present invention populates appetites based on an analysis of the trading history of all insurance carriers for each class, line, and product, and then for each product by location, industry, segment and client size. Insurance carriers are preferably rated based on how much of a particular risk type they wrote in the prior twelve (12) months.

For instance, appetites are calculated at the following levels:
Class
Line
Product
Product by location of risk
Product by industry (at four levels of specificity)
Product by segment
Product by client size (turnover band)

A first step in the appetite derivation process is to identify policies written across the ‘in scope’ business units at each of these levels—and then to calculate the percentage share of each insurance carrier against the total premiums written.

It is noted, statistically, these insurance carrier shares form a distribution with mean x and standard deviation sigma. Often however, one or two markets may dominate the distribution causing a skew that distorts the statistics. Thus, to eliminate this skew, any insurance carrier that has a share of premium at each level greater than three times sigma is awarded an appetite score of 4 and is removed from the distribution. Any insurance carrier that has a share of premium at each level lower than three times sigma (below the mean) is preferably awarded an appetite score of 1 and is also removed from the distribution. The distribution statistics are then re-computed, and each insurance carrier is awarded a score of 1, 2 or 3 dependent on where they fall in the percentiles of that curve.

It is noted that in accordance with an illustrated embodiment of the present invention, ratings for premium competitiveness have no default score. This rating can however be changed by upon review of carrier propositions.

A Quality Index for each insurance carrier is based on qualitative opinions of each insurance carrier. Preferably, insurance carriers are evaluated on four areas of service:
Underwriting: including commerciality, coverage, responsiveness, continuity, and collateral;
Policy Administration: including timeliness and accuracy of policy documentation;
Claims: including attitude, settlement, technical support, timely approval, timely payment, and relationship focus; and
Service: including post placement service, electronic trading, loss control, and risk assessment.

Scores are preferably collated for each of these dimensions by location (country) and class of business, and are input into the present invention Market Match database.

### Dynamic Scores

In accordance with an illustrated embodiment of the present invention, dynamic scores are preferably calculated at the following levels (consistent with the static scoring methodology):
Product;
Product by location of risk;
Product by industry (at four levels of specificity);
Product by segment; and
Product by client size (turnover band).

Preferably, at each level, two ratios are calculated:
Submitted to quoted; and
Submitted to bound.

The ratios are preferably converted to a score out of 5 based on thresholds. Specifically, a dynamic score of 5 is awarded if the ratio is greater than 60%, 4 if between 50% and 60%, 3 if between 40% and 50%, 2 if between 30% and 40%, 1 if between 20% and 30% and 0 if the ratio is less than 20%.

The scores (for each ratio and at each level), making up a total of 10 separate scores, are then weighted and aggregated and finally expressed as a % score out of 100 (with 100% representing the maximum possible score across all levels and ratios). This percentage is then multiplied by the weighting for dynamic scoring (vs. static). It is further noted, and in accordance with the illustrative embodiment of the present invention, a further factor is applied in the above analysis to ensure that a statistically relevant number of transactions have been processed before awarding a dynamic score. Preferably, only ratios derived from sample sizes greater than 10 are included (at each level), and the weighting factors adjusted accordingly. With reference to FIG. 3, illustrated is an exemplary screen shot of the aforesaid present invention indicating Market Match results.

In accordance with the illustrated embodiment, each dynamic score is preferably reduced if the carrier has less than 4 submissions as follows: 1 submission reduces the score to 25% of its full value, 2 submissions reduce the score to 50% and 3 submissions to 75%. If a carrier has 4 or more submissions they keep 100% of the score.

Therefore, the present invention is advantageous in that Market Match provides insurance carriers with a greatly enhanced distribution model. By using the present invention to translate insurance carrier offerings into Market Match scores, insurance carriers are able to target business development opportunities and improve their product offerings to clients. Market Match data enables insurance carriers to better understand client needs and provide an insight into a brokers' Market appraisal process.

Additionally, the vast amount of data used in the above described present invention Market Match process generates a superior product at efficient prices from the best suitable insurance Carrier, with increased client access to specialist markets. One reason being specific client priorities are captured and used during the market matching, ensuring a tailored solution, and client feedback is highly valued and fed back into the system throughout.

Another advantage is the present invention market match increases transparency across a carrier selection network, exposing potential issues and tracking performance at a detailed level. Users are not bound by the matches suggested, but will find that the process increases their awareness of potential products and encourages them to explore new possibilities, based on strong empirical reasons. Users will be provided with a tool that tracks all successful and unsuccessful placements, which will generate statistics that can be used to support claims made when in discussion with both insurance carriers and clients.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described.

The above presents a description of a best mode contemplated for carrying out the present invention system and method for selecting an insurance carrier, and of the manner and process of making and using them, in such full, clear, concise, and exact terms as to enable any person skilled in the art to which it pertains to make and use these devices and methods. The present invention system and method for selecting an insurance carrier is, however, susceptible to modifications and alternative method steps from those discussed above that are fully equivalent. Consequently, the present invention system and method for selecting an insurance carrier is not limited to the particular embodiments disclosed. On the contrary, the present invention system and method for selecting an insurance carrier encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A processor-implemented method to match client insurance needs with an insurance carrier, comprising:
create profiles for each of a plurality of insurance carriers by collating data from database sources relevant to each of said plurality of insurance carriers;
provide a structured format for a client to indicate insurance needs; and
matching a client needs with collated data to identify at least one of said plurality of insurance carriers.

2. A processor-implemented method as recited in claim 1, wherein said data sources include data accumulated through matching activity of prior client insurance needs.

3. A processor-implemented method as recited in claim 2, wherein said accumulated data includes bottom-up data.

4. A processor-implemented method as recited in claim 2, wherein said accumulated data includes top-up data.

5. A processor-implemented method as recited in claim 1, wherein said step of providing a structured format provides a client ability to selectively weigh individual insurance need parameters.

6. A processor-implemented method as recited in claim 1, wherein for each said matched and indentified insurance carrier, the following data is provided: carrier rank; market security rating; and content regarding said identified insurance carrier's offering for an identified risk type.

7. A processor-implemented method as recited in claim 1, wherein insurance carriers having collated data which are new market entrants are identified to a client as a new market entrants.

8. A processor-implemented method as recited in claim 1, wherein said matching step includes determining a static score and a dynamic score for each said match.

9. A processor-implemented method as recited in claim 8, wherein said static score is determined by static data indicative of an appetite of an insurance carrier for a certain insurance risk.

10. A processor-implemented method as recited in claim 8, wherein said dynamic score is determined by aggregated dynamic data relating to an insurance carrier.

11. A processor-implemented method as recited in claim 9, wherein said appetite is calculated by class, line, product, product by location of risk, product by industry, product by segment and product by client size.

12. A processor-implemented method as recited in claim 9, wherein said dynamic score is calculated by product, product by location of risk, product by industry, product by segment and product by client size.

13. A computer system instructed to match client insurance needs with an insurance carrier, comprising:
means to create profiles for each of a plurality of insurance carriers by collating data from database sources relevant to each of said plurality of insurance carriers;
means to provide a structured format for a client to indicate insurance needs wherein a client has the ability to selectively weigh individual insurance need parameters; and
means to match a client needs with collated data to identify at least one of said plurality of insurance carriers whereby each match is provided with a determined static score and a dynamic score.

14. A computer system instructed to match client insurance needs with an insurance carrier as recited in claim 13, wherein said data sources include data accumulated through matching activity of prior client insurance needs.

15. A computer system instructed to match client insurance needs with an insurance carrier as recited in claim 14, wherein said accumulated data includes bottom-up data.

16. A computer system instructed to match client insurance needs with an insurance carrier as recited in claim 14, wherein said accumulated data includes top-up data.

17. A computer system instructed to match client insurance needs with an insurance carrier as recited in claim 13, wherein for each said matched and indentified insurance carrier, the following data is provided: carrier rank; market security rating; and content regarding said identified insurance carrier's offering for an identified risk type.

18. A computer system instructed to match client insurance needs with an insurance carrier as recited in claim 13, wherein insurance carriers having collated data which are new market entrants are identified to a client as a new market entrants.

19. A computer system instructed to match client insurance needs with an insurance carrier as recited in claim 13, wherein said static score is determined by static data indicative of an appetite of an insurance carrier for a certain insurance risk.

20. A computer system instructed to match client insurance needs with an insurance carrier as recited in claim 13, wherein said dynamic score is determined by aggregated dynamic data relating to an insurance carrier.
